(19) United States
(12) Patent Application Publication
(10) Pub. No.: US 2022/0314115 A1
(43) Pub. Date: Oct. 6, 2022

(54) PROGRAM, GAME SYSTEM, INFORMATION PROCESSING DEVICE, AND SERVER DEVICE

(71) Applicant: BANDAI CO., LTD., Tokyo (JP)

(72) Inventors: Yoshito MOTEKI, Tokyo (JP); Mitsuha MINAMINAKA, Tokyo (JP); Ryan MILLER, Seattle, WA (US)

(21) Appl. No.: 17/640,273

(22) PCT Filed: Sep. 3, 2020
(86) PCT No.: PCT/JP2020/033400

§ 371 Date: Mar. 3, 2022

(30) Foreign Application Priority Data
Sep. 4, 2019 (JP) 2019-161435

(51) Int. Cl. A63F 13/45; A63F 13/35; A63F 13/822; A63F 13/537

(52) U.S. Cl. CPC A63F 13/45; A63F 13/35; A63F 13/822; A63F 13/537; A63F 2300/303; A63F 2300/807

(57) ABSTRACT

This program provides improved entertain in the progression of a computerized, turn-based competitive game involving a first player and a second player. The game progresses while presenting a first game element used in the game and a second game element which indicates which player has an action turn in the game. The program causes the computer to acquire information of the first game element on the basis of the use determination; determine a placement position for presenting the second game element in response to the information of the first game element being acquired; determine which player has the action turn on the basis of the determined element placement position for the second game; and control the progression of the competitive game on the basis of the result of the action turn determination.

### CROSS REFERENCE TO RELATED APPLICATIONS

This application is a national stage application, filed under 35 U.S.C. § 371, of International Application No. PCT/JP2020/033400, filed Sep. 3, 2020, which claims priority to Japan Application No. 2019-161435, filed Sep. 4, 2019, the contents of both of which as are hereby incorporated by reference in their entirety.

### BACKGROUND

### Technical Field

The present invention relates to a program, a game system, an information processing device, and a server device, and particularly relates to an electronical game executing what is known as a turn-type battle game.

### Background Art

Recently, trading card games (TCGs) have been developed beyond a mode in which players gather around a table and play the game using tangible cards, and are now popularly played, with terminals executing a corresponding electronic game, using virtual cards on the game.

The TCG progresses with two players involved in a battle alternately taking action turns (attack/defense turn). Each player can make an attack action on various cards of an opponent player placed on a field, by placing an attack card (such as a character) on the same field from a hand in his or her action turn. Then, the player who has satisfied a condition for knocking out the opponent player in several turns is determined to be a winner.

In TCGs, generally, a cost is determined in advance for an attack card, meaning that while the game is in progress, a player can place the card on the field and make an attack action by consuming his or her points by an amount corresponding to the cost. In the interest of fairness of the game, for example, a higher cost and stricter condition is assigned for placing a card providing a higher advantage in the game progress in the field. In other words, a player needs to perform an action to increase his or her points by not placing an attack card with a high cost for several action turns, until he or she accumulates enough points for placing the attack card on the field (Patent Document 1).

### DESCRIPTION OF RELATED ART

Patent Document 1: Japanese Patent Application Publication No. 2006-247178

### BRIEF SUMMARY

### Problem to be Solved by the Invention

As described above, there may be some turns in which the player only performs the action to increase his or her points in the TCG. This may make the game dull or result in a long playing time to compromise the excitement or interest of the player. In conventional TCGs, a player basically cannot be involved in points the opponent player accumulated or whether the opponent player can make an attack action. This may result in a situation where the game becomes less exciting. For example, it may be difficult for a player with a much smaller points than that of the opponent player to get even with the opponent.

The present invention is made in view of the problem described above, and an object of the present invention is to provide a program, a game system, an information processing device, and a server device that realize a battle game with a more exciting game progression.

### Solution to the Problem

A program of the present invention causes a computer that executes a turn-type battle game, participated by a first player and a second player, progressing through presentation of a first game element determined to be used for the game and a second game element indicating which of the players is taking the action turn in the game in progress, to execute: processing of acquiring information on the first game element based on the determination to use the first game element; processing of determining a placed position of second game element to be presented, in response to the acquisition of the information on the first game element; processing of deciding which of the players takes the action turn based on the determined placed position of the second game element; and processing of controlling the progress of the battle game based on a result of deciding the action turn.

### Advantageous Effects of the Invention

With this configuration, the present invention can realize a trading card game with a more exciting game progression.

### BRIEF DESCRIPTION OF THE FIGURES

FIG. 1 is a diagram illustrating an example of a configuration of a game system according to an embodiment of the present invention;

FIG. 2 is a block diagram illustrating an example of a functional configuration of a server 100 according to the embodiment of the present invention;

FIG. 3 is a block diagram illustrating an example of a functional configuration of a smartphone 200 according to the embodiment of the present invention;

FIG. 4 is a diagram illustrating an example of a digital game card used in a battle game executed in the game system according to the embodiment of the present invention;

FIG. 5 is a diagram illustrating an example of a game screen presented on the smartphone 200 for the battle game according to the embodiment of the present invention;

FIG. 6 is a diagram illustrating a turn presentation unit indicating an action turn, for the battle game according to the embodiment of the present invention;

FIG. 7 is a diagram illustrating an example of game processing executed in the server 100 according to the embodiment of the present invention;

FIG. 8 is a diagram illustrating a turn presentation unit, for a battle game according to a modification of the present invention; and

FIG. 9 is a diagram illustrating an example of a configuration of character information managed in a character DB 104 of the server 100 according to the embodiment of the present invention.

### DETAILED DESCRIPTION OF VARIOUS EMBODIMENTS

An embodiment will be described in detail below with reference to the attached drawings. The embodiment described below does not limit the invention according to the scope of claims. Not all the combinations between features described in the embodiment are necessarily essential for the invention. Any two or more of a plurality of features described in the embodiment may be combined as appropriate. Furthermore, the same or similar configurations are denoted by the same reference numeral, and the redundant description thereon will be omitted.

In one embodiment described below, an example is described in which the present invention is applied to a smartphone as an example of client device that can execute a program related to a game application for a trading card game (TCG) that is a turn-type battle game according to the present invention, and a server that communicates with the smartphone executing the program to realize a battle participated by a player using the smartphone. However, the present invention can be applied to any device that can realize a turn-type battle game participated by a first player and a second player.

In this specification, a “game card (on an electronic game or virtual)” used by a player in a battle game is associated with any of the characters appearing in the battle game, and the description is given assuming that when a game card is used, a character having a unique ability associated with the game card becomes operable. Thus, the “game card” used and the “character” are equivalent, and these terms are selectively used as appropriate in a way that makes the invention more easily understandable.

Configuration of Game System

[symbol]

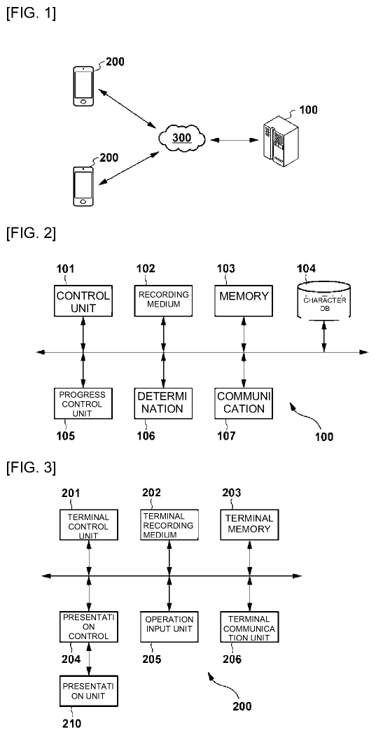

A system configuration of a game system according to an embodiment of the present invention will be described with reference to FIG. 1.

As illustrated, in the game system, the server 100 is configured to be connected with a plurality of smartphones 200 over a network 300, to be capable of providing a play experience of a battle game according to the present embodiment. More specifically, when a program related to an application for the battle game is executed in the smartphone 200, the smartphone 200 and the server 100 are communicably connected with each other, and the server 100 identifies player information associated with a user (player) of the smartphone 200 to establish a usable state. When an instruction for starting the battle game is issued in the smartphone 200, the server 100 identifies, as a battle opponent for the player of the smartphone 200, a player satisfying a predetermined condition, and starts control for executing the battle game between the players.

While the battle game proceeds, the content of an operation related to the game performed on the smartphone 200 is transmitted to the server 100. The server 100 performs calculation and determination of a presented content based on the content of the operation, and transmits the resultant information to the smartphone 200 of each of the players participating in the battle game. In the smartphone 200, the information received is reflected on a game screen presented on a presentation unit 210 of the smartphone 200. Specifically, an action performed by one of the players participating in the battle game during his or her action turn is reflected on the game screen of the smartphone 200 used by the other player, to be shared between the players. Thus, in the game system according to the present embodiment, basically, the generation of the game screen related to the battle game is performed in the smartphone 200, and acquisition, configuration, and management of the information presented on the screen are performed in the server 100.

The content presented on the screen related to the battle game is described to be synchronized between the smartphones 200 of the players participating in the game, but the screens presented is not limited to the same screen. The synchronization may occur at least due to any of the actions performed, as a result of the action, and based on information indicating which of the player is taking the action turn as described later. The display mode thereof may be determined for each smartphone 200, and may reflect a favorable configuration (such as orientation, notation, and customizable elements) for the player of the smartphone 200. Thus, the information for screen presentation, managed by and transmitted to each smartphone 200 by the server 100, is configured to enable the equivalent screens to be configured on the two smartphones 200 referring to the information for screen configuration.

As will be described in detail later, the battle game provided by the game system of the present embodiment is a turn-type game, with one player (first player) and the other player (second player) alternately taking the action turns. The switching between the action turns occurs based on an operation performed by the player and determined by the server 100.

The battle game executed by the game system of the present embodiment is a TCG enabling two players to engage in an online battle. The game is executed without using a tangible card, but is executed using a virtual card on the game (an element configured by digital data and corresponding to a tangible card, which will be referred to as a game card in the following description). Thus, the players only need to execute a program for the game application on the smartphone 200 to play the battle game. Information on the game card usable by each player for the game play may be managed in association with information for identifying the player in the server 100.

### <Configuration of Server>

Next, a functional configuration of the server 100 will be described with reference to a block diagram in FIG. 2.

A control unit 101 is a CPU for example, and controls operations of blocks of the server 100. Specifically, the control unit 101 reads an operation program of each block recorded in a recording medium 102 for example, loads the program onto a memory 103, and executes the program to control the operation of each block.

The recording medium 102 is a recording device such as a non-volatile memory or an HDD for example, which can permanently hold data. The recording medium 102 stores information such as parameters required for the operation of each block, in addition to the operation program for each block of the server 100. The memory 103 is a storage device such as a volatile memory, for example, used for temporary data storage. The memory 103 is not only used as an area onto which the operation program of each block is loaded, and is also used as a temporary storage area for data and the like output as a result of the operation of each block.

A character DB 104 is a database for managing information (character information) on each battle character configured as a game card to be usable in the battle game.

The character information managed for one battle character may be managed as one record in the database, and have a data configuration as illustrated in FIG. 9 for example. As illustrated, the character information includes, in association with a character ID 901 uniquely identifying a battle character and a card ID 902 identifying a game card associated with the character: cost information 903 that is first numerical value information according to the present invention, defining a numerical value (cost) required for using the character (or the game card) in the battle game; battle information 904 that is second numerical value information according to the present invention, defining a numerical value (attack value) referred to for resolving a battle action using the character; and supplementary information 905 that is information on an effect provided for and constraints in use of the character. These various types of information managed in the character information are referred to for progress control for the battle game, for making the battle character appear or for using the game card associated with the character. The character information is described to have the configuration illustrated in FIG. 9 in the present embodiment, but this is merely for simplifying the description, and the embodiment of the present invention is not limited thereto. The cost and the battle action related to the use of the battle character will be described in detail later.

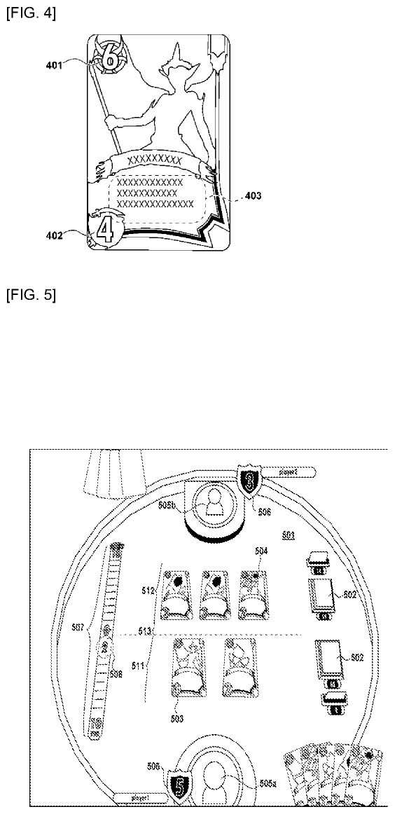

In the battle game of the present embodiment, each battle character is presented in a form of a game card as illustrated in FIG. 4, on the smartphone 200 as described later. To enable the player to plan a strategy for the battle game, the game card presented includes display for a cost 401 and an attack value 402 managed for the corresponding battle character. The supplementary information related to the battler character is presented in an area 403 displaying the game card.

A progress control unit 105 performs progress control for the battle game executed in the game system. The progress control for the battle game is performed based on the content of an operation performed on the smartphone 200 as described above, character information managed in the character DB 104, and turn information for managing action turns for the game in progress.

A determination unit 106 determines which of the players takes the action turn in the battle game in progress. The action turn in the battle game of the present embodiment does not change in response to a turn end instruction from a player as in conventional TCGs, and may change in accordance with an action performed during the action turn. Thus, the determination unit 106 determines which of the player takes the turn, as appropriate.

A communication unit 107 is a communication interface of the server 100 for communicating with an external device. The communication unit 107 connects with the external device over the network 300 (either wired or wireless) which may be a communication network such as the Internet or a cable connecting between devices, to be capable of exchanging data with the external device. The communication unit 107 converts received information to be transmitted into data of a predetermined format for example, and transmits the data to the external device such as the smartphone 200 over the network 300. For example, upon receiving the information from the external device over the network 300 for example, the communication unit 107 decodes the information, and stores the information in the memory 103.

### <Configuration of Client Device>

Next, a functional configuration of the smartphone 200 will be described with reference to a block diagram in FIG. 3.

A terminal control unit 201 is a CPU for example, and controls operations of the blocks of the smartphone 200. Specifically, for example, the terminal control unit 201 reads operation programs for the blocks and the game-application related program, recorded in a terminal recording medium 202, loads the program onto a terminal memory 203, and executes the program to control the operation of the blocks.

The terminal recording medium 202 is a recording device such as a nonvolatile memory or an HDD for example that can permanently hold data. The terminal recording medium 202 stores, in addition to the operation programs for the blocks of the smartphone 200, information such as parameters required for the operations of the blocks, and various types of graphics data used for the battle game executed by the smartphone 200. The terminal memory 203 is a storage device, such as a volatile memory for example, used for temporary data storage. The terminal memory 203 is not only used as an area onto which the operation program for each block is loaded, but is also used as a storage area for temporarily storing data and the like, output as a result of the operation of each block.

The presentation control unit 204 is in charge of controlling presentation, on the smartphone 200, of various types of information to the player. The smartphone 200 of the present embodiment is described as including the presentation unit 210 that displays a screen (such as a game screen or other screens such as an OS menu screen) for presenting various types of information to the player. However, how the information is presented is not limited thereto, and those described above may be replaced or another unit may be added as a matter of course.

A presentation control unit 204 includes a rendering device such as a GPU for example, and executes predetermined rendering processing for generating a game screen to be displayed by the presentation unit 210. Specifically, the presentation control unit 204 executes various types of calculation processing based on processing and command executed by and issued from the terminal control unit 201, an operation input made using an operation input unit 205, and information for screen presentation received, to render and generate various game screens related to the battle game, while the game application is being executed. The game screen thus generated is output to and displayed by the presentation unit 210 provided to the smartphone 200, to be presented to the player.

The presentation unit 210 is a display device, such as an LCD for example, provided to the smartphone 200. In the present embodiment, the presentation unit 210 is described as being incorporated in and integrated with the smartphone 200. However, the embodiment of the present invention is not limited thereto, and the unit may be a wired or wireless external display device detachably connected to the smartphone 200 for example.

The operation input unit 205 is a user interface, such as a touch panel or a button for example, provided to the smartphone 200. Upon detecting an operation input by the player, the operation input unit 205 outputs a control signal corresponding to the operation input, to the terminal control unit 201. The terminal control unit 201 configures information indicating the operation content based on the control signal, and transmits the information to the server via a terminal communication unit 206 described later.

The terminal communication unit 206 is a communication interface provided to the smartphone 200 for communicating with other devices. The terminal communication unit 206 establishes a connection with an external device over a network for example, using a predetermined (wired or wireless) communication scheme, to exchange data therewith. The game application program, data required for rendering, and the like may be configured to be receivable from an external device via the terminal communication unit 206.

With the smartphone 200 of the present embodiment, a battle game with a player using the other smartphone 200 can be executed via the server 100. Thus, some contents presented while the battle game progresses are not something that can be configured using locally stored data only, and need to be configured using a result of the processing in the server 100. Thus, it is assumed that while the battle game is in progress, the smartphone 200 receives the information for screen presentation from the server 100 as appropriate, and configures and presents a screen with contents reflecting the information, upon receiving the information. In the present embodiment, a detailed description on the processing for the present will be omitted. Still it should be noted that when the information for the screen presentation is received, the contents to be presented as indicated by the information needs not to be reflected and presented at once on the game screen, and may be controlled to be reflected on the game screen in a predetermined presentation order.

Game Overview

[symbol]

Next, an overview of the battle game of the present embodiment will be described with reference to FIG. 5 illustrating a game screen presented on the smartphone 200 while the battle game is in progress.

Each player is provided with a deck 502 the combination of which is determined to satisfy a predetermined condition, and acquires (draws) cards in order from the deck 502 to make a hand. A battle character associated with a game card, making up the hand, can be in a state of being usable in the battle game (participate as an action target) only when the card is placed on a game field 501 serving as a field. Thus, a game card that is in the hand and thus is not exposed (placed) on the game field 501 is not in a state of being used by the player, and is only in a state of being held as a usable candidate.

The battle character in the usable state can be made to perform a battle action that is basically aimed at excluding a battle character of the opponent player that is in the usable state from the game field 501. Winning or losing of the battle action is determined based on battle information associated with the battle character. Upon being instructed with the battle action, the progress control unit 105 resolves the battle action. This “resolving” means to obtain a result of the action instructed, and may be replaced with other terms when the present invention is applied to games other than TCG.

In the game system of the present embodiment, the battle action is resolved by comparing a battle value indicated by the battle information on the battle character performing the battle action and the attack value of the battle character of the opponent player that is the target of the action, and knocking out one of the battle characters with a smaller value. In this process, for the interest of fairness (to prevent a one-sided game as a result of repeated battle actions), the action of the battle character with the larger attack value ends, and the battle character transitions to a temporarily unusable state until the player takes the next action turn. In other words, after the action, the battle character with the larger value cannot perform another action during the ongoing action turn.

Specifically, when a player (a player on the closer side in the figure, a first player) using a client device on which the screen illustrated in FIG. 5 is displayed performs an instruction, to a battle character 503 that is usable as a result of placing his or her game card on the game field 501, the instruction to perform a battle action on a battle character 504 of an opponent player (a player on the farther side in the figure, a second player) that is also usable, the attack values of these characters are compared. As a result, the battle character 504 with the smaller value is knocked out, to be excluded from the game field 501. On the other hand, the battle character 503 with the larger attack value will be in a state of being incapable of performing further actions during the ongoing action turn.

Note that the progress control unit 105 performs control so that when the attack values of the battle characters involved in the battle action are the same, both battle characters are knocked out to be excluded from the game field 501.

Game cards 504a and 504b corresponding to avatar characters of the respective players are further placed on the game field 501. The condition for winning the battle game is knocking out the avatar character of the opponent player, meaning that a player loses if his or her character is knocked out.

As illustrated in FIG. 5, the avatar character is associated with a fixed resistance value 506 of an initial value, indicating that the avatar character is basically provided to be capable of resisting the number of battle actions, performed thereon by a battle character, as indicated by the resistance value. More specifically, at the points when the battle game starts, the avatar character is assigned with a defense deck comprising game cards facing down, the number of which matching the initial value of the resistance value. When a battle action is performed on the avatar character, the resistance value is consumed by one, and one game card from the defense deck is placed on the game field 501 to have the corresponding battle character used for the defense in the battle game. This game card is for the defense purpose, and is not determined to be used during the action turn of the corresponding player (the avatar character that is the target of the battle action), meaning that the corresponding battle character can be used without consuming a cost described later. On the other hand, the battle character (defense character) placed on the game field 501 to be usable for the purpose of defense cannot be used for purposes other than the defense against the battle action on the avatar character, and thus is under a restriction of being excluded from the game field 501 when the current action turn ends regardless of the result of the battle action. Thus, no matter how strong the defense character is, the player associated with the character cannot make the defense character perform the battle action in his or her subsequent action turns.

Thus, also when a battle action is performed on the avatar character, the action is resolved through comparison in attack values between the battle character performing the battle action and the defense character, as in the case of the battle action performed between the battle characters. However, the battle action performed on the avatar character is different from the battle action performed between the battle characters, in that the battle action on the avatar character is continuously performed until the character is knocked out as a result of the resolution of the battle action by the battle character. Specifically, when an instruction for making a single battle action on the avatar character is made, the action continues until a defense character having an attack value overwhelming that of the battle character making the action appears from the defense deck. Thus, the player, the avatar character of which has been exposed to the battle action, performs defense by placing the game cards from the defense deck on the game field 501 with the resistance value consumed one by one, until the end condition for the battle action is satisfied.

When the battle action is further made by a character of the opponent player on the avatar character in a state of having the resistance value reduced to 0, that is, when the avatar character is selected to be the target of the battle action for the number of times, including the continuous actions, exceeding the resistance value by 1, the avatar character is knocked down, and this process ends the battle game. In other words, the avatar character is a character which cannot defend itself against the battle action, meaning that a battle action made with no defense character present succeeds without fail, to knock out the avatar character. Thus, when the defense characters appearing from the defense deck are knocked out by the battle actions, with the continued battle action, the avatar character is knocked out successively

### <Action Turn Determination>

Next, a method of determining which of the players takes the action turn, performed by the determination unit 106 in the battle game of the present embodiment will be described.

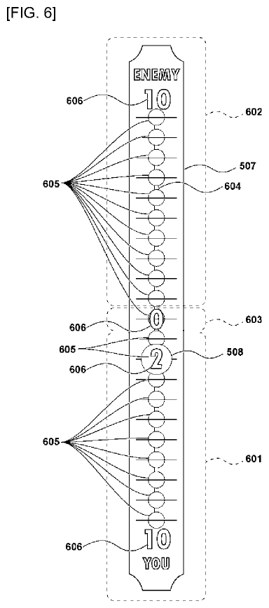

In the battle game of the present embodiment, a placed position of an indicator icon 508, which is a second game element in a turn presentation unit 507 provided on the game screen in FIG. 5, indicates which of the players is taking the action turn. Now, control for presenting the action turn using the turn presentation unit 507 will be further described with reference to FIG. 6.

As illustrated in FIG. 6, the turn presentation unit 507 includes a first area 601 associated with the first player, a second area 602 associated with the second player, and a third area 603 provided at the boundary portion therebetween. The determination unit 106 determines which of the player takes the action turn, depending on which of the areas include the indicator icon 508 configured to have the placed position movable.

More specifically, the determination unit 106 determines that the first player takes the action turn, when the indicator icon 508 is placed in the first area 601, and determines that the second player takes the action turn when the indicator icon 508 is placed in the second area 602. The third area 603 is an area associated with none of the players. When the indicator icon 508 is placed in the area as a result of the movement, the determination unit 106 makes the action turn determination based on which of the areas the indicator icon 508 was placed before the movement, for the sake of smooth progress of the battle game. Specifically, the determination unit 106 determines that the first player takes the action turn if the indicator icon 508 was placed in the first area 601 immediately before the indicator icon 508 is placed in the third area 603, and determines that the second player takes the action turn when the indicator icon 508 was placed in the second area 602.

As described above, in the battle game of the present embodiment, the turn-type battle game is realized through a change/movement of the placed position of the indicator icon 508. The change in the placed position of the indicator icon 508 occurs when a battle character is determined to be used and when a battle action using a battle character is determined to be used. In other words, in the battle game of the present embodiment, the placed position of the indicator icon 508 in the turn presentation unit 507 changes when an instruction to place a game card in the hand on the game field 501 is made and when an instruction to make the battle action is made for the game card thus placed.

Basically, the direction in which the indicator icon 508 moves in response to the instruction is set to be a direction from the first area 601 to the second area 602 when the first player is taking the action turn, and is set to be a direction from the second area 602 to the first area 601 when the second player is taking the action turn.

The amount of change in (movement of) the placed position of the indicator icon 508 differs depending on the instruction made. If the instruction made relates to the determination to use the battle character, the amount is set in proportion to the numerical value set to the battle character corresponding to the game card for which the instruction has been made. On the other hand, when the instruction relates to the execution of the battle action using the battle character determined to be used, the amount is set to a fixed value determined in advance. The amount of movement in the latter case is basically set to be smaller than that in the former case, to increase the chance of the player selecting the action in the latter case. This is because the placement of (determination to use) a game card related to a battle character on the game field 501 requires the movement of the indicator icon 508 by an amount corresponding to a value unique to the character, and the requirement of the movement each time a character with a high unique value set is used would end up in a less smooth progress of the battle game

In the battle game of the present embodiment, the placed position of the indicator icon 508 in the turn presentation unit 507 is limited to be in any of cells 605 provided on a path 604 presented on the turn presentation unit 507 as illustrated in FIG. 6, to facilitate planning of the strategy in determining which action is to be taken. Thus, the amount of movement of the indicator icon 508 is counted by the number of cells.

Thus, as illustrated, a plurality of cells are provided in the first area 601 and the second area 602 on the path 604, and only a single cell is provided in the third area 603. With only a single cell 605 (center cell) provided in the third area 603, the placed position of the indicator icon 508 before the movement can be prevented from being none of the first area 601 or the second area 602.

Some of the cells on the path 604 are configured to be presented with a natural number 606 indicating the number of cells corresponding to the distance from the center cell, attached. To clearly indicate the distance from the center cell to the position of the cell 605 in which the indicator icon 508 is currently placed, such a natural number 606 may also be presented for the cell 605 in which the indicator icon 508 is placed.

In the present embodiment, when an instruction to determine the use of a certain battle character is made, the number of cells over which the indicator icon 508 moves is set as a cost determined for the battle character. Specifically, when the first player performs an operation to determine the use for the game card corresponding to a battle character with the cost set to “6”, the placed position of the indicator icon 508 changes from the current placed position to the next placed position which is a cell separated from the current cell by six cells in the direction from the first area 601 to the second area 602. Thus, as illustrated in FIG. 6, when the indicator icon 508 is placed in a cell, in the first area, assigned with the natural number “2”, the determination to use the battle character with the cost 6 would result in the indicator icon 508 moving by six cells to be at a cell, in the second area 602, assigned with the natural number “4”.

With such a configuration, in the battle game of the present embodiment, a situation can be avoided where the excitement and interest of the player are compromised due to none of game cards in the hand being placeable in the game field or a battle action being not performable with any of the game cards placed during his or her action turn. In each action turn, while an operation related to a game card can be performed at least once, the amount of movement of the indicator icon 508 in the turn presentation unit 507 is determined in accordance with the cost determined for the target game card, whereby the excitement in terms of the tactical aspect between the players increases. In other words, a player can control a range of actions that can be performed by the opponent player in the next action turn, based on the use determination and the game card (battle character) that performs the battle action, so that the tactical aspect of the battle game can be increased further.

Note that in the described mode of the battle game of the present embodiment, as illustrated in FIG. 5, the first area 601, the second area 602, and the third area 603 are used commonly with an area 511 in which the game card of the first player is placed, an area 512 in which the game card of the second player is placed, and a boundary area 513 therebetween, in the game field. Specifically, in the turn presentation unit 507 of the present embodiment, the area 511 in which the game card related to the first player is placed to be presented in the game field is provided to serve as the first area 601, the area 512 in which the game card related to the second player is placed to be presented in the game field is provided to serve as the second area 602, and the boundary area 513 between these areas where the game cards are placed is provided to serve as the third area 603. However, the embodiment of the present invention is not limited thereto, and the turn presentation unit 507 may be provided at a different position in the game field 501 or may be provided in an area outside the game field 501 in the screen.

When the placed position of the indicator icon 508 changes in the turn presentation unit 507 in response to an instruction made in the battle game, the transition of the movement is presented on the screen presented on the smartphone 200. Specifically, when the placed position of the indicator icon 508 included in the information for the screen presentation received is different from the one before the reception, the presentation control unit 204 controls the presentation mode of the indicator icon 408 to implement the sequential movement from the placed position before the reception to the placed position indicated by the information for the screen presentation received. The movement of the indicator icon 508 may be synchronized with a timing at which the game card determined to be used is placed and presented on the game field 501 (or at which the battle action is presented), or may start being presented during the action turn of the corresponding player after this timing. In this case, when the action turn of the corresponding player continues in a state where another operation is receivable after the operation related to the movement of the indicator icon 508, the movement of the indicator icon 508 is preferably completed before the situation where the other operation is received.

The TCG described as the battle game of the present embodiment is merely one example, and the game may include any detailed rules and the like, as long as the placed position of the second game element is determined in response to the determination to use the first game element (game card), and the determination on which of the players takes the action turn is determined based on this placed position. The one example is merely given for facilitating the understanding of the processing flow, and the embodiment of the present invention is not limited thereto.

Game Processing

[symbol]

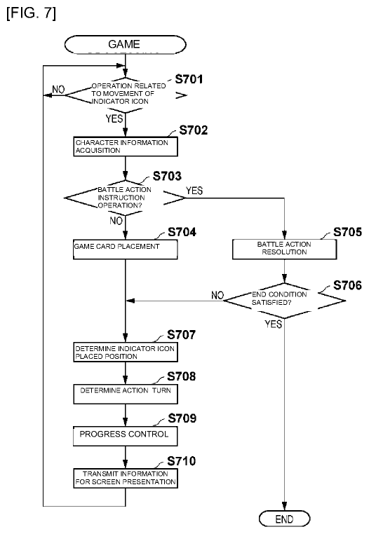

Hereinafter, specific game processing executed in the server 100 to realize the battle game between two players in the game system of the present embodiment will be described with reference to a flowchart in FIG. 7. Processing corresponding to the flowchart can be realized when the control unit 101 reads out a corresponding processing program stored in the recording medium 102 for example, loads the program onto the memory 103, and executes the program. The description is given assuming that the game processing starts when matching between the smartphones 200 used for the battle game is completed, and when the state where the play experience of the battle game can be provided is established in both devices. This state where the play experience of the battle game can be provided is assumed to be a state where preparation processing before the game starts, including deck selection, determination of deck arrangement order, defense deck determination, hand delivery, determination on which of the players takes the first action turn, and the like, has been completed, and any one of the players can input an operation to make the battle game progress.

In S701, under the control by the control unit 101, the progress control unit 105 determines whether an operation related to the movement of the indicator icon 508 has been performed on the smartphone 200 of the player (action player) taking the current action turn. Specifically, the progress control unit 105 determines whether an operation related to an instruction for newly placing a game card, in the hand, on the game field is made or an operation related to an instruction for a battle action is made on a game card already placed on the game field, on the smartphone 200 of the action player. The determination in this step is made based on information on the content of the operation received from the smartphone 200 of the action player. The progress control unit 105 moves the processing to S702 upon determining that the operation related to the movement of the indicator icon 508 has been made, and repeats the processing in this step upon determining that the operation has not been made yet.

For other operations performed on the smartphone 200 for the battle game of the present embodiment, descriptions on processing executed in the server 100, as well as processing of configuring information for screen presentation presented on the smartphone 200 in response to the operations will be omitted for the sake of simplicity of the description. In the TCG, the placement (the drawn order) of the game cards in the deck is determined at least at the time when the battle game starts, and thus, a game card newly added to the hand in the action turn needs not to be presented to the opponent player. Thus, some processing may be executed and have the presentation controlled locally in the smartphone 200, instead of being presented on the game screens between a plurality of smartphones 200.

In S702, under the control by the control unit 101, the progress control unit 105 acquires the character information on a battle character (target character) associated with the game card as the operation target, from the character DB 104. The processing in this step may be executed by identifying and acquiring the character information managed in the character DB 104, based on information on the character ID of the target character that is the operation target of the card ID of the game card that is the operation target, included in the operation content information received from the smartphone 200 of the action player for example.

The character information acquired in this step is not limited to that on the battle character associated with the action player, and one on the battle character associated with the opponent player that is the action target may be included. When the battle action target is the avatar character of the opponent player, in this step, character information on a character (a character at the top of the defense deck) used as the defense character is acquired.

The information on the game card placed in the game field (field information) is managed in the server 100 for each battle game in which battle is being executed, and is shared between the smartphones 200 participating in the game. The information managed as the field information may include for each player, for example, information on which game card is placed on the game field, as well as character information corresponding to each game card, information (action flag: FALSE indicating the end of the action (changed to TRUE each time the action turn starts)) indicating whether action can be performed in the current action turn (whether the action has ended), and information on the avatar character (information on the remaining resistance value and on defense deck). The field information is, for example, stored in the memory 103 in the server 100 for example, and is updated as appropriate, such as in response to the reception of an instruction related to the movement of the indicator icon 508.

In the processing in this step, if the information on the relevant battle character has already been acquired to be included in the field information, the control for acquiring the information from the character DB 104 may not be performed. In this case, the progress control unit 105 may refer to the field information stored in the memory 103, and not in the character DB 104, to acquire the required character information.

In S703, under the control performed by the control unit 101, the progress control unit 105 determines whether the operation performed is an operation related to an instruction for the battle action. The progress control unit 105 moves the processing to S704 upon determining that the operation performed is the operation related to an instruction for the battle action. The progress control unit 105 moves the processing to S706 upon determining that the operation performed is not the operation related to an instruction for the battle action, that is, upon determining that the operation performed is the operation related to the use determination.

In S704, under the control performed by the control unit 101, the progress control unit 105 executes the processing for resolving the battle action based on the instruction. The processing in this step is executed based on the character information acquired in S702. More specifically, the progress control unit 105 compares a numerical value indicated by cost information 903 on a target character associated with the action player and a numerical value indicated by the cost information 903 on a target character associated with the opponent player, related to the battle action, and determines the character to be knocked out (excluded from the game field). The progress control unit 105 deletes the information on the character determined to be knocked out, from the field information. For the character that is not knocked out as a result of the resolution, the progress control unit 105 updates the action flag managed for the character in the field information, to FALSE.

When the character that is the target of the battle action is the avatar character, the progress control unit 105 may execute processing of updating the resistance value of the avatar character included in the field information to a value decremented by 1, and knocking out the defense character. Although the detailed description on the processing will be omitted, when the target of the battle action is the avatar character, the end condition for the battle action is satisfied when a defense character with an attack value overwhelming that of the battle character performing the battle action appears from the defense deck. Thus, the processing of comparing the attack values of the battle character performing the battle action and the defense character might be executed a plurality of times until the battle action is resolved. When the defense character that would end the relevant action does not finally appear, and the resistance value of the avatar character decreases to 0, the battle action on the avatar character succeeds successively, and thus the progress control unit 105 also knocks out the avatar character.

In S705, under the control performed by the control unit 101, the progress control unit 105 determines whether the end condition for the battle game is satisfied. As described above, the end condition for the battle game of the present embodiment is execution of the battle action on the avatar character with the resistance value 0 as a result of the resolving the battle action, and thus in this step, the progress control unit 105 determines whether this condition is satisfied. Upon determining that the end condition for the battle game is satisfied, the progress control unit 105 executes various types of processing related to ending the battle game, such as end display and communication disconnection processing, and then ends the game processing. Upon determining that the end condition for the battle game has not been satisfied, the progress control unit 105 moves the processing to S707.

On the other hand, upon determining that the operation performed is not the operation related to the instruction for the battle action, the progress control unit 105 executes processing of placing a game card, related to the battle character determined to be used in S706, in the game field, under the control performed by the control unit 101. Specifically, the progress control unit 105 performs updating by adding the character information on the battle character determined to be used, which was acquired in S702, to the field information.

In S707, the progress control unit 105 determines the placed position of the indicator icon 508 in the turn presentation unit 507 under the control performed by the control unit 101. Specifically, the progress control unit 105 determines a cell in which the indicator icon 508 is to be placed, based on the numerical value of the cost information 903 in the character information acquired for the battle character associated with the action player, if the operation related to the movement of the indicator icon 508 is an operation related to the use determination. The progress control unit 105 determines a cell in which the indicator icon 508 is placed, based on a predetermined numerical value (fixed value: 1), if the operation related to the movement of the indicator icon 508 is an operation related to the instruction for the battle action.

In S708, the determination unit 106 determines which of the players takes the next action turn, based on the information on the placed position of the indicator icon 508 determined in S707 under the control performed by the control unit 101. As described above, which of the players takes the action turn is determined based on which of the first area 601, the second area 602, and the third area 603 includes the cell in which the indicator icon 508 is placed, in the turn presentation unit 507. For example, when the action player is the first player, the determination unit 106 determines that the action player (first player) remains unchanged, if the cell in which the indicator icon 508 is placed is a cell provided in the first area 601 or the third area 603, and determines to change the player taking the action turn to the second player, if the cell in which the indicator icon 508 is placed is a cell provided in the second area 602.

In S709, the progress control unit 105 performs game progress control under the control performed by the control unit 101. In this step, the progress control may be performed based on the action resolution result or a result of determining the action turn in S708.

In S710, the progress control unit 105 configures the screen presentation information referred to for generating a screen based on an operation performed on the smartphone 200 by the action player, and transmits the information to the communication unit 107 to make the communication unit 107 transmit the information to the smartphones 200, under the control performed by the control unit 101. When the transmission of the screen presentation information is completed, the progress control unit 105 makes the processing return to S701.

The screen presentation information may include display information related to the result of the operation made, field information, and display information related to the turn presentation unit 507. The screen presentation information is stored in the terminal memory 103 of each smartphone 200 upon being received by the smartphone 200. The presentation control unit 204 refers to the screen presentation information for generating a screen of the battle game in progress to generate a game screen reflecting game cards placed on the game field, the current status of the game card, a result of an operation made by the action player, and the status of the turn presentation unit 507, and makes the presentation unit 210 display the screen. The screen displayed on the smartphone 200 based on the operation performed by the action player may include presentation with a display mode differing over a plurality of frames.

As described above, with the game system of the present embodiment, a battle game with exciting game progress can be realized. More specifically, in a turn-type battle game participated by the first player and the second player, the placed position for presenting the second game element is determined in response to determination to use the first game element in the battle game, and which of the players takes the action turn is determined based on the placed position of the second game element thus determined. The progress of the battle game is controlled based on the action turn determination result. Specifically, the game system presents the second game element, the presented position of which indicating which of the player is taking the action turn, and this presented position is changed when the player determines to use the first game element in the battle game. Which of the players takes the action turn is determined based on the presented position of the second game element, to make the processing related to the battle game reflect the result corresponding to the presentation. With this configuration, the player can determine to use the first game element without the need to perform a dull action, and with the action turn determination made based on the use determination instruction, favorable game progress can be realized.

In the present embodiment, an example is described where the present invention is applied to the game system including the server 100 and the smartphones 200 connected over the network 300, but the embodiment of the present invention is not limited thereto. Specifically, in the present embodiment, a mode is described in which the turn-type battle game participated by the first player and the second player is executed with a device (client device) receiving an operation instruction and presenting a screen, and a device (server) determining the presentation contents and determining the action turn being different from each other. However, the embodiment of the present invention is also applicable to a mode in which the battle game is executed in a single device such as a home video game machine, a game console, and the like. The embodiment of the present invention may also be applied to a mode in which a plurality of client devices directly communicate with each other without having a server involved. In this case, the function described as being executed in the server 100 may be provided to any of the client devices. In other words, the battle game may be executed with one of the client devices serving as a host to also function as the server.

### First Modification

Each player has to strategically select and use game cards in a plurality of game cards making up the hand in his or her action turn, meaning that performing an action without switching the action turn to the opponent player as much as possible is important. Meanwhile, even though the natural number is added to be presented, with the mode in which the placed position of the indicator icon 508 in the turn presentation unit 507 indicates the action turn, the player may not be able to immediately identify the position of the indicator icon 508 upon determining the use of the game card in the hand. As a result, the player may determine to use an unintended game card, and this may lead to unintentional switching of the action turn. In the present modification, a mode in which the determination to use an unintended game card by the action player will be described.

Advance Notification Display Related to Action Turn

[symbol]

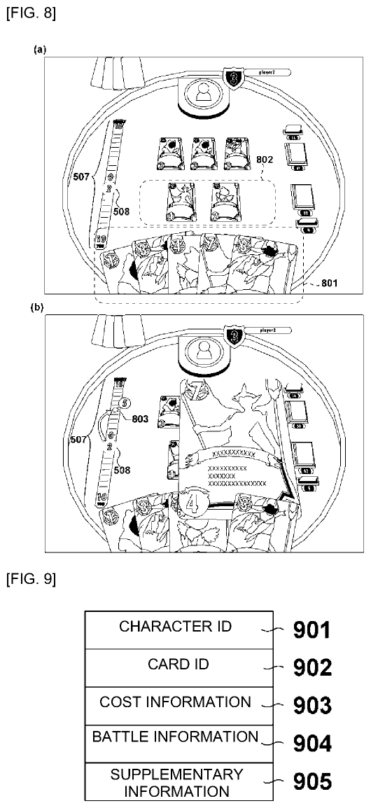

FIG. 8 is a diagram illustrating an example of a mode of a game screen presented on the smartphone 200 used by the player taking the action pattern in the game system according to the present modification.

As illustrated in FIG. 8(a), in the action turn of each player, candidates of game cards to be used by the player are placed, as the hand, in an area 801 to be presented on the game screen. The action player determines to use a game card by dragging and dropping a desired one of the game cards making up the hand placed in the area 801, to an area 802 in which the game card determined to be used is presented in the game field 501.

A configuration enabling the player to check the details of the game card placed in the area 801 for the hand is advantageous in terms of an improvement in a tactical aspect of the battle game. In view of this, in the game system of the present modification, each player can establish a touched state of any of the game cards in the area 801, to make the game card presented in a mode under which the details of the same can be checked as illustrated in FIG. 8(b).

The game card in this state is determined to be in a selected state, and as illustrated, an advance notification icon 803 is presented in the turn presentation unit 507 on the game screen, in addition to the indicator icon 508, to indicate the position to which the indicator icon 508 moves when the game card is determined to be used. The placed position of the advance notification icon 803 is determined to be a cell separated from the cell where the indicator icon 508 is placed, in the direction toward the area of the opponent player, by the cost of the game card in the selected state, as illustrated in FIG. 8(b).

In the example illustrated in FIG. 8(b), a mode is illustrated in which, of the game cards placed in the area 801, a game card with a cost “7” is in the selected state. The game card in the selected state is presented while being larger than the other game cards in the area 801. The current placed position of the indicator icon 508 in the turn presentation unit 507 is a cell associated with the natural number “2”. Thus, the placed position of the advance notification icon 803 is determined to be a cell associated with the natural number “5” in the area of the opponent player. Control is performed to add and present information on the natural number to the cell where the advance notification icon 803 is to be placed. Thus, the player taking the action turn can check in advance how the advanced notification icon 803 will be if he or she determines to use a game card in the hand, whereby strategy planning for the battle game is facilitated.

Information on the selected state needs not to be transmitted to the server 100 each time such presentation control is performed. The control may be performed by the presentation control unit 204 in the smartphone, and can also be performed through the server 100. In the mode in which the present invention can be applied to the battle game without involving the server 100 as described above, such processing may be executed in a device having the function of the server 100.

### Second Modification

In the embodiment and the modification described above, the turn is not switched by a turn end instruction, and the action turn determination is made based on the movement of the indicator icon. Still, the end instruction may be accepted because there may be a situation where a player has no hand, or presentation of a game card is strategically unfavorable. In this case, the placed position of the indicator icon 508 in the turn presentation unit 507 may be determined to be a cell in the area of the opponent player associated with a natural number (such as 3 for example) determined in advance.

### Third Modification

In the embodiment and the modification described above, the turn presentation unit 507 is provided with the third area 603. When the indicator icon 508 is placed in this area, any of the players may take the action turn. Specifically, when the indicator icon 508 is placed in the third area 603, which of the players takes the action turn is determined based on which of the first area and the second area where the indicator icon 508 was placed before moving to the area. The indicator icon 508 is placed in the third area 603 at the beginning of the battle game, and the player assigned with the first action takes the action turn.

Unfortunately, with this specification of the turn presentation unit 507, it may be difficult to instantaneously recognize which of the players takes the action turn by looking at the game screen, when the player temporarily takes his or her eyes off the screen or when the smartphone 200 recovers from the suspended state. More specifically, the player may not be capable of instantaneously determining which of the players takes the action turn, when the indicator icon 508 is placed in the third area 603.

Thus, to avoid such a situation, the turn presentation unit 507 of the present invention may be configured to have no third area 603, that is, no cell in which the indicator icon 508 can be placed at the boundary portion between the first area 601 and the second area 602. In other words, the turn presentation unit 507 may be configured to be in a mode in which an area with which one of the players taking the action turn differs depending on the situation is eliminated, with a cell in the first area 601 assigned with the natural number “1” and a cell in the second area 602 assigned with the natural number “1” placed adjacent with each other with no other cell provided in between.

In this case, when the player taking the first action turn after the battle game starts is determined, the indicator icon 508 may be placed at a cell, in the player side area, allocated with the natural number “1”. With this configuration, as in the embodiment and the modification described above, the first operation made for moving the indicator icon 508 would definitely results in switching the action turn to the opponent player.

### Other Embodiments

The present invention is not limited to the embodiments described above, and can be changed/modified in various ways within the range of the spirit of the present invention, without departing from the gist of the invention. The game system according to the present invention can be realized by a program making one or more computers function as the game system. The program can be provided/distributed by being recorded in a computer readable recording medium or through electrical communication lines.

### EXPLANATIONS OF LETTERS OR NUMERALS

100: server,
101: control unit,
102: recording medium,
103: memory,
104: character DB,
105: progress control unit,
106: determination unit,
107: communication unit,
200: smartphone,
201: terminal control unit,
202: terminal recording medium,
203: terminal memory,
204: presentation control unit,
205: operation input unit,
206: terminal communication unit,
210: presentation unit,
300: network

1. A program executed via a computer that executes a turn-type battle game involving a first player and a second player, progressing through presentation of a first game element determined to be used for the game and a second game element indicating which of the players is taking an action turn in the turn-type battle game, wherein the program causes the computer to:
acquire information on the first game element based at least in part on a determination to use the first game element;
determine a placed position of the second game element within a presentation of at least a portion of the turn-type battle game, in response to the acquisition of the information on the first game element;
determine which of the first player or the second player takes the action turn based at least in part on the determined placed position of the second game element; and
control the progress of the turn-based battle game based at least in part on a result of determining the action turn.

2. The program according to claim 1, wherein in the turn-based battle game the first game element is presented to be selectable for at least one of the first player or the second player as a candidate for use in the turn-based battle game and the program further causes the computer to generate a notification of the placed position of the second game element in response to the determination to use the first game element.

3. The program according to claim 2, wherein generating the notification of the placed position of the second game element includes:
identifying the placed position of the second game element presented when the first game element is placed in a selected state and is determined to be used; and
of placing and presenting an additional game element at the identified placed position.

4. The program according to claim 1, wherein the first game element is embodied as a plurality of first game elements, wherein each of the plurality of the first game elements is associated with first numerical value information indicating a numerical value involved in the determination to use the first game element, and the placed position of the second game element is determined based at least in part on the numerical value indicated by the first numerical value information associated with the corresponding first game element.

5. The program according to claim 4, wherein the placed position of the second game element is a new placed position determined to be a position separated from an old placed position of the second game element before the determination, by an amount corresponding to the numerical value indicated by the first numerical value information associated with the corresponding first game element.

6. The program according to claim 5, wherein the first game element and the second game element are placed on a game field of the turn-based battle game to be presented.

7. The program according to claim 6, wherein when the placed position of the second game element changes from the old placed position to the new placed position, the second game element is moved from the old placed position to the new placed position on the game field.

8. The program according to claim 6, wherein the game field includes a first area and a second area, and when the placed position of the second game element is in the first area, the first player is decided to be taking the action turn, and the when the placed position of the second game element is in the second area, the second player is decided to be taking the action turn.

9. The program according to claim 8, wherein the game field further includes a third area between the first area and the second area, and when the placed position of the second game element is in the third area, the first player is determined to be taking the action turn when the old placed position of the second game element is in the first area, and the second player is decided to be taking the action turn when the old placed position of the second game element is in the second area.

10. The program according to claim 9, wherein the placed position of the second game element is determined to be in any of a plurality of cells placed on a predetermined path extending on the game field to pass through the first area, the second area, and the third area, and the plurality of cells include a plurality of first cells placed in the first area and the second area, and one cell placed in the third area.

11. The program according to claim 10, wherein a natural number is assigned to each of the first cells in the first area and the second area and wherein the natural number increases with an increasing distance from the cell placed in the third area on the predetermined path, and at least one of the first cells is presented as including the corresponding assigned natural number.

12. The program according to claim 11, wherein the cell that is the placed position of the second game element is presented as including the corresponding assigned natural number.

13. The program according to claim 10, wherein the new placed position of the second game element is determined to be, when the first player is taking the action turn, a cell separated from the cell that is the old placed position, in a direction away from the first area and toward the second area, by a number of cells corresponding to the numerical value indicated by the first numerical value information associated with the corresponding first game element, and determined to be, when the second player is taking the action turn, a cell separated from the cell that is the old placed position, in a direction away from the second area and toward the first area, by a number of cells corresponding to the numerical value indicated by the first numerical value information associated with the corresponding first game element.

14. The program according to claim 1, wherein the second game element placed at the new placed position is presented (a) simultaneously with the presentation of the first game element, or (b) while the action turn of a same player of the first player or the second player is continuing after presentation of the corresponding first game element.

15. The program according to claim 1, wherein controlling the progress of the turn-based battle game includes:
receiving, for the first game element determined to be used by one of the first player or the second player, an instruction to perform a battle action to the first game element determined to be used by another one of the first player or the second player; and
resolving the battle action in response to the instruction for the battle action,
wherein each of the first game elements is associated with second numerical value information indicating a numerical value related to the battle action and the second numerical value information has a value smaller than the first numerical value information, and
wherein resolving the battle action by knocking out one of the first game element of the one player and the first game element of the other player involved in the battle action.

16. A game device that executes a turn-type battle game involving a first player and a second player, progressing through presentation of a first game element determined to be used for the game and a second game element indicating which of the players is taking an action turn in the turn-type battle game, the device components configured to:
acquire information on the first game element based at least in part on a determination to use the first game element;
determine a placed position of second game element within a presentation of at least a portion of the turn-type battle game, in response to the acquisition of the information on the first game element;
determine which of the first player or the second player takes the action turn based at least in part on the determined placed position of the second game element; and
control the progress of the turn-based battle game based at least in part on a result of determining the action turn.

17. A game system comprising:
a server the realizes a turn-type battle game involving a first player and a second player, progressing through presentation of a first game element determined to be used for the game and a second game element indicating which of the players is taking an action turn in the turn-type battle game; and
client devices used by the first player and the second player, wherein the server is configured to:
acquire information on the first game element based at least in part on a determination to use the first game element made in one of the client devices;
determine a placed position of second game element within a presentation of at least a portion of the turn-type battle game, in response to the acquisition of the information on the first game element;
determine which of the first player or the second player takes the action turn based at least in part on the determined placed position of the second game element; and
control the progress of the turn-based battle game based at least in part on a result of determining the action turn.

18. A server that provides a play experience of a turn-type battle game involving a first player and a second player, progressing through presentation of a first game element determined to be used for the game and a second game element indicating which of the players is taking an action turn in the turn-type battle game, to client devices used by the first player and the second player, the server configured to:
acquire information on the first game element based at least in part on a determination to use the first game element made in one of the client devices;
determine a placed position of second game element within a presentation of at least a portion of the turn-type battle game, in response to the acquisition of the information on the first game element;
determine which of the first player or the second player takes the action turn based at least in part on the determined placed position of the second game element; and
control the progress of the turn-based battle game based at least in part on a result of determining the action turn.
